(19) United States
(12) Patent Application Publication
(10) Pub. No.: US 2011/0167070 A1
(43) Pub. Date: Jul. 7, 2011

(54) REUSING ASSETS FOR PACKAGED SOFTWARE APPLICATION CONFIGURATION

(75) Inventors: Rema Ananthanarayanan, New Delhi (IN); Manisha D. Bhandar, Hawthorne, NY (US); Kathleen Byrnes, Piscataway, NJ (US); Charbak Chatterjee, Kolkata (IN); Shyhkwei Chen, Hawthorne, NY (US); Maharshi Desai, Fairfax, VA (US); Pankaj Dhoolia, New Delhi (IN); Sweefen Goh, Hawthorne, NY (US); Richard T. Goodwin, Hawthorne, NY (US); Mangala Gowri, New Delhi (IN); Anca A. Ivan, San Jose, CA (US); Juhnyoung Lee, Hawthorne, NY (US); Senthil Kk Mani, New Delhi (IN); Pietro Mazzoleni, Hawthorne, NY (US); Rakesh Mohan, Hawthorne, NY (US); Debdoot Mukherjee, New Delhi (IN); Aubrey J. Rembert, Hawthorne, NY (US); Gerhard Sigl, Essex Junction, VT (US); Manas R. Kumar Singh, Kolkata (IN); Vibha S. Sinha, New Delhi (IN); Biplav Srivastava, New Delhi (IN)

(73) Assignee: INTERNATIONAL BUSINESS MACHINES CORPORATION, Armonk, NY (US)

(21) Appl. No.: 12/652,978

(22) Filed: Jan. 6, 2010

(51) Int. Cl. G06F 17/30

(52) U.S. Cl. 707/741; 707/769; 707/765; 707/E17.014; 707/E17.074; 707/759; 707/E17.002

(57) ABSTRACT

Reusing assets for packaged software application configurations may include defining one or more query criteria based on information associated with a project, querying an asset repository stored in a storage device using the one or more query criteria, receiving a list of one or more assets from the asset repository in response to the querying, and using the one or more assets on the list to compose a document defining deployment procedures associated with deploying a packaged software application.

### BACKGROUND

The present disclosure relates generally to computer applications, and more particularly to managing information relating to the configuration and deployment of packaged software applications. One example of a packaged software application is an Enterprise resource planning (ERP) application, a company-wide computer software system used to manage and coordinate all the resources, information, and functions of an organization from shared data stores. An ERP service project is a complex activity relating to the deployment of packaged software application, which involves months, sometimes, years of effort from many consultants. Consultants in such projects often rely on a large amount of various documents as the primary means to gather and share information and knowledge, often by using office productivity tools such as document editors, spreadsheet tools, drawing and presentation tools. Information stored using such tools are difficult to reuse, and often the data created and stored using those tools are difficult to compile. For example, the productivity tools do not provide any way to access, collate and report on the information.

### BRIEF SUMMARY

A method and system for reusing assets for packaged software application configurations are provided. The method, in one aspect, may include defining one or more query criteria based on information associated with a project, querying an asset repository stored in a storage device using the one or more query criteria, receiving a list of one or more assets from the asset repository in response to the querying, and using the one or more assets on the list to compose a document defining deployment procedures associated with deploying a packaged software application.

A system for reusing assets for packaged software application configurations, in one aspect, may include a storage device including an asset repository storing a plurality of assets and associated data objects. A project setter module may be operable to receive a list of one or more assets from the asset repository in response to querying the asset repository using one or more query criteria based on information associated with a current project. A work product composer module may be operable to search and retrieve additional assets from the asset repository. A work product generator module may be operable to generate a document defining deployment procedures associated with deploying a packaged software application for the current project using the one or more assets, the associated data objects, and the additional assets.

A computer readable storage medium storing a program of instructions executable by a machine to perform one or more methods described herein may be also provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a flow diagram illustrating a method in one embodiment for finding assets by using work product models for packaged application practices.

FIG. 2 is a flow diagram illustrating a method in one embodiment for applying assets.

FIG. 3 is a block diagram illustrating a system in one embodiment for creating, linking and using work product models for packaged application practices integrated in conjunction with other functional modules that may utilize the system and method of the present disclosure.

FIG. 4 illustrates an example of a template of a work product and mapping of elements of the template into model of objects.

FIG. 5 illustrates a screen shot listing a plurality of assets returned from an asset repository.

FIG. 6 illustrates an example of a computer system, in which the systems and methodologies of the present disclosure may be carried out or executed.

### DETAILED DESCRIPTION

The present disclosure is directed to methods and systems that find assets in a work product, for example, for use in packaged software application deployment and configurations. The assets found may be used to compose work products to be applied for deploying and configuring a plurality of different packaged software applications.

“Service delivery methods” generally refer to methods for deploying and configuring software applications in an organization. Service delivery methods define work products in projects. Examples of service delivery methods may include Ascendant™ methods for the SAP™ practice, and OUM™ (Oracle Unified Method) for the Oracle practice. Ascendant™ methods for the SAP™ practice refer to complete methods for implementing SAP software in an organization. It includes a structured approach to what needs to be done, when it needs to be done, how it should be done, and how it should be controlled. Similarly, Oracle Unified Method (OUM) was developed by Oracle™ and is an iterative and incremental software development process framework for supporting the successful implementation of all Oracle products—applications, middleware, and database.

“Work products” refer to documents, for example, usually in paper or in electronic form or the like, rendered, for example, from tools such document editors, graphics editors, spreadsheet tools, e.g., Microsoft™ Word™, PowerPoint™, Excel™, Visio™, Adobe PDF™, HTML, and others. A piece of computer code or program such as the WRICEF is another example of work product. WRICEF refers to workflows, reports, interfaces, conversions, enhancements and forms, commonly used in SAP projects. Work products are related to business artifacts. In the system and method of the present disclosure, the logic of a work product may be externalized in models, for example, in extended mark language (XML) or other structured form, and physically rendered to those documents, as needed. Examples of work product may include but are not limited to documents specifying the following: Mission Statement, Technical Infrastructure Scope, Initial Risk Mitigation Strategy, Initial Project Scope, Implementation and Rollout Strategy, Project Team Organization Structure, Updated Project Plan, Project Team Training Plan, Legacy System Change Strategy, Capacity Planning Strategy, Archiving Strategy, Communications Plan, Project Documentation Standards, Technical Design Document, Development System, Backup Strategy, Production Support Plan Deployment, Project Review and Signoff, and others.

“Business artifact” refers to an information entity that is produced and shared in the course of the application life cycle such as requirements, gap, process, functional specification, technical specification and others. Gap refers to the difference between the as-is status and to-be (desired) status, in terms of transformation, i.e., organization's process, IT and organization structure. Transformation using packaged applications such as SAP™ and Oracle™ systems is an activity to fill the gap to transform the enterprise to the desired status.

A “template” of one or more work products refers to a representation of work products for consumption captured in paper or the like. Templates are usually prepared for a service delivery method, e.g., to deploy and configure software applications. Templates include one or more sections (e.g., introduction, requirements, metrics, etc.) with styles and forms (e.g., font, color, etc.). Template, for example, may be one single document or different documents or different versions of documents, for instance, in a text editor form such as Microsoft™ (MS) WORD™. A template, for example, has a standard format and content of a work product type that, for example, service delivery method consultant(s) may start with to create a work product instance. In the traditional art, both templates and work product instances are physical objects in some word processing file such as MS™ Word™ or Excel™ document. The system and method of the present disclosure separates the logical object (i.e., model) from the physical object (i.e., work product in MS™ Word™ or the like). With the system and method of the present disclosure, work can be done in the logical object while the physical objects (e.g., in MS™ Word™) can be generated when needed. The term “work product template” is used interchangeably with the term “template” in this disclosure, and both terms refer to a template of one or more work products as described herein.

A “model” of one or more work products refers to structured representation of one or more work products for machine and/or computer program consumption, captured, for example, in XML or other markup language or structured data format or the like. Models may be created in the method and system of the present disclosure. Each model may include one or more objects.

An “object” in a model is a representation of a work product document, section or element of one or more work products or the like. Models are said to be “shredded” into multiple objects. That is, a model may be divided into multiple objects. Each object may include content, style elements of a work product, and additional metadata.

A “link” is a representation of a relationship between objects across one or more work product models. Examples of relationships may include repetition (e.g., overlap among two or more work products), dependency, and association. For instance, “Business process” may be linked to a “requirement” or a “gap” which is, in turn, linked to a “gap resolution”, which is, in turn, linked to “use cases”, “test cases”, “test scripts”, “test plans”, and others, in an ERP project.

“Assets” are work products and other project materials. We use the term “objects” to refer to elements and components of work products, especially in the context of models of work products. Examples of work products and assets may include PDD (Process Definition Document), Requirement, GAP, RICEFW, etc.

A “starter set” is a set of assets (work products and other project materials and documents) from previous projects that can be reused for the present project, searched and selected from the asset repository based on the characteristics of the present project scope.

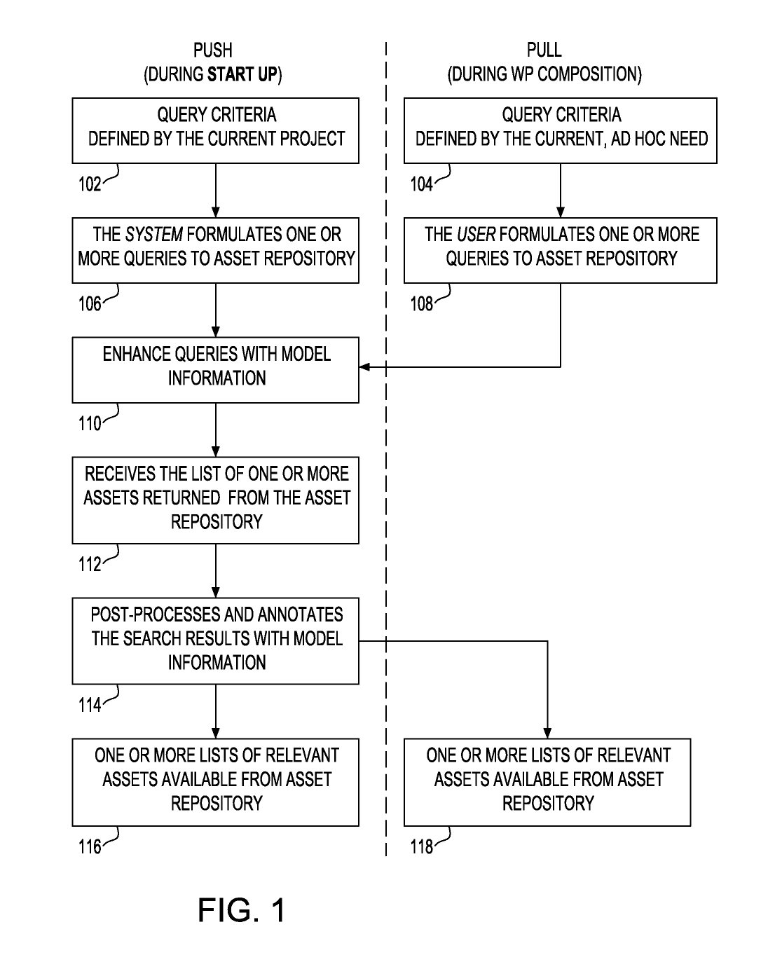

FIG. 1 is a flow diagram illustrating a method in one embodiment for finding assets that may be used for packaged software application configuration. At 102, one or more query criteria are defined by the current project. Examples of query criteria may include but are not limited to, Business Process Hierarchy (BPH), product and features, geographical locations and/or countries, organization structure, method phases, work product types, and others. For instance, for a service delivery project, the scope of the project may be defined according to one or more of client's industry, business processes, packaged applications, geographical locations and others. The scope of the project thus may define the specific context of the work products needed for the project. This context may be translated into one or more queries on the asset repository that stores assets to retrieve the assets that may be used for this project.

Searching of the assets may be performed by a push method during start up. Additionally or alternatively, searching of the assets may be performed by a pull method, for example, during work product composition as shown at 104.

At 106, for push method searching, a system or program module of the present disclosure automatically formulates one or more queries to asset repository. For instance, the defined project scope is translated into the one or more search queries using linguistic computation, information retrieval, search techniques, text parsing and/or semantic analysis. Query string, for example, may be formed by using search engines or the like, parameters used to store assets, specification on the content needed, and others. For example, assets may have been stored in an asset repository along with the various metadata or attributes of the assets. Those attributes may be used in search queries as parameters, for instance, to enhance the retrieval and precision of the search results. Example of the asset attributes or search parameters may include, but are not limited to, asset name, description, contributor, creator, version, date added, modified, asset category, relationships to other assets, and others. In a “push” mode, the results of the query are “pushed” to the user, and thus the user may be considered as being “passive.”

At 108, in a “pull” mode, a user may formulate one or more queries to the asset repository, and thus actively search for assets. As in the push mode, the query strings may include parameters, specification on the content needed, and others.

At 110, the queries may be enhanced with model information. For example, in work product models stored in the asset repository, work product objects (e.g., content) may be tagged (e.g., to specify the category and property of the object and/or content). The object tags may be considered as asset attributes, and may be used in a similar way to enhance the search queries, for instance, to improve the precision and recall (retrieval) of search results.

At 112, a list of assets returned from the asset repository as a result of performing the one or more queries is received.

At 114, the list is processed and annotated with model information. For instance, the search results (assets returned from the one or more queries) may be post-processed before presenting them to the user, using the metadata, attributes, model tags and their metadata, and others, and adding more details or annotations. Related assets may be also suggested.

In addition, the relevance of the returned assets may be evaluated, scored and ranked.

At 116 and 118, one or more lists of relevant assets are made available from the asset repository.

The assets so found with their model and the model of the work products may be used to generate client project specific work products. This set of work products may form a “best practice” starter set that the user can modify to meet project's needs. For instance, there may be multiple assets that match a given query and the user may select one or more parts from different ones to create the starting work product. During the life of the project, the context specified above may change and or become more complete. The updated context may be used to periodically generate new queries on the asset repository and more or different assets may be found as the result of the performing the new queries. Furthermore, the user may directly browse or search the repository to reuse assets into their work products.

In addition, the asset relationship information may be used as a modified “page rank” algorithm for selecting assets.

The reused assets may be annotated with the information of reuse, for example, on which project they were reused. Each asset may have “asset signature” or “thumbnails” by which the asset may be searched. Furthermore, visualization may be provided, for example, visualizing the linkage of assets, the history of reuse of assets, and others.

An enhanced module such as a recommendation engine, for example, being trained and having trained data, may be used to recommend what assets to use and not use for certain or selected projects. The reuse percentage of assets may be computed in a project and how reuse correlates to success of a project may be assessed.

In addition, an aging control mechanism may be provided for assets.

Relationship information about the assets may be stored and/or presented to the user. For instance, information such as “the user who liked this asset also liked this other asset” may be stored and used. Such and other relationship information among the assets may be maintained and they may be changed dynamically. In addition, all viewable and searchable assets may be summarized by one or more dimensions, for example, by process, product, project and customer, and other.

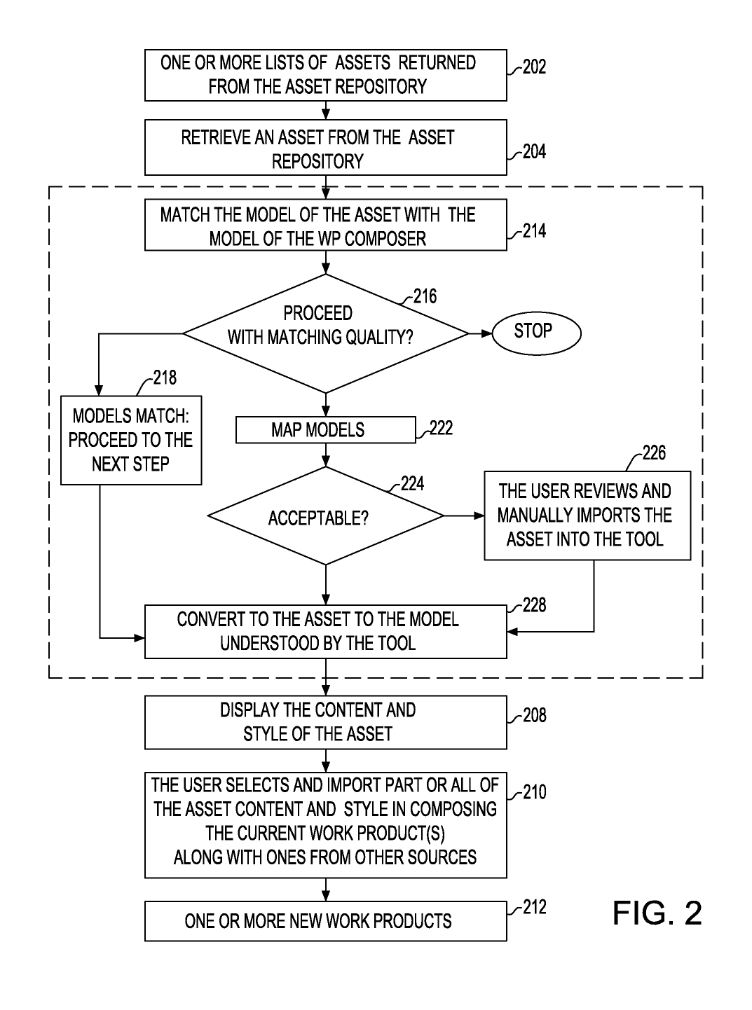

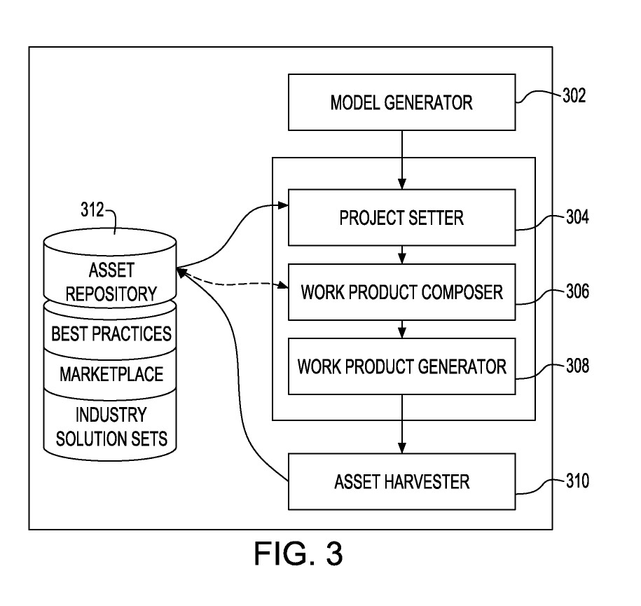

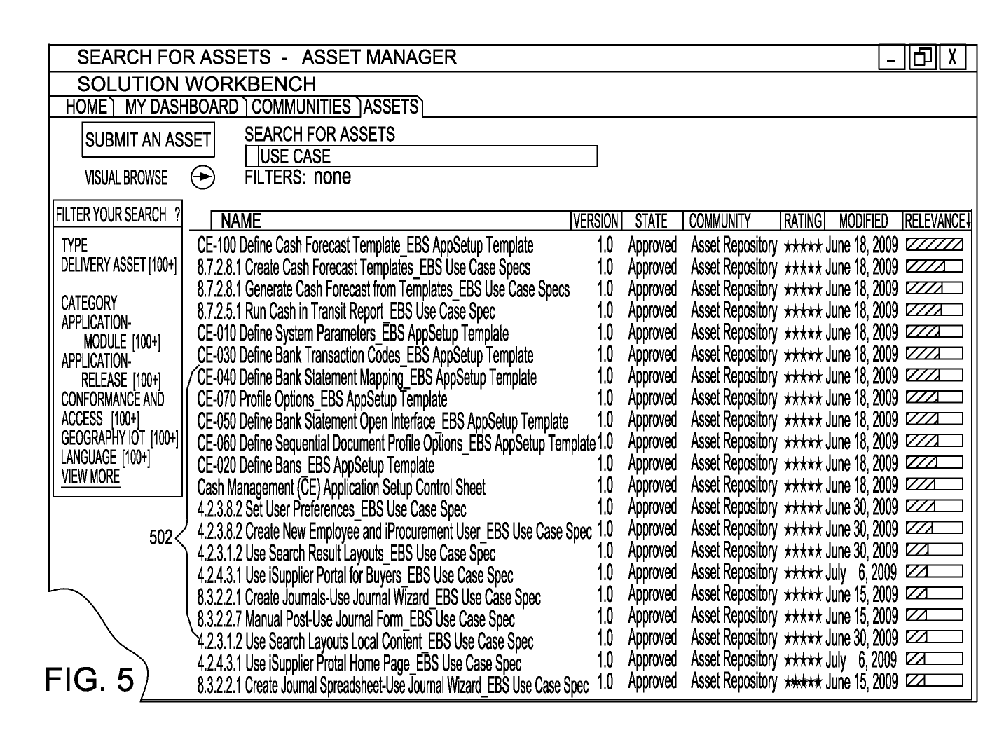

FIG. 2 is a flow diagram illustrating a method in one embodiment for applying the assets. At 202, one or more assets are returned from the repository, for instance, as described with reference to FIG. 1. An asset may include a group of work products in one embodiment. Each work product or document is also referred to as artifact. That is, an asset may have one or more artifacts. For the search results presented for human users, the assets are usually presented as a whole, for example, as one or more documents (artifacts). Then the user may further select one or more artifacts from the returned assets. The artifacts the user selects also may have associated model representation, i.e., objects that represent the content of the artifacts and links that represent the relationships between the content of the artifacts, and/or other information. The model representation may be an internal computer representation, and thus may be hidden from user's point of view. In one embodiment, this model representation may be visualized, for example, as nodes and links. The artifact and its model representation generally carry the same information. The difference may be that the artifact is for human, and the model representation is for computer program. When the artifact is imported for composing a work product, e.g., into a work composer module of the present disclosure, (e.g., Work Product Composer 306 shown in FIG. 3), the work composer module may utilizes the model representation for processing and creating new work product out of it—still all content may be stored in the model (instance). Eventually, when it is physically rendered, for example, by a work product generator of the present disclosure (e.g., Work Product Generator 303 shown in FIG. 3), we have a representation for human consumption, for example, in a form of an electronic or paper document. FIG. 5 illustrates a screen shot that lists the results of the search for assets. The assets 502 returned are those that may be reused for the current project.

Referring to FIG. 2, a user may select and retrieve one or more assets listed in the returned search result from an asset repository. At 206, the one or more models of the assets are mapped against the current work product under composition. At 208, the content and style of the assets are displayed. At 210, the selected part or all of the asset content and style are imported to compose the current work products. At 212, one or more new work products are generated.

In one embodiment, the step of mapping one or more models of the assets may further include the following. At 214, one or more models of the asset are matched with the model used currently by a model composer for composing a work product. The model used currently by a model composer refers to a model of work products used in the current version of a work product composer. For example, given that the work product composer software can evolve over time, that the work product model used in the work product composer can also evolve over time, that the assets stored in an asset repository are harvested from different engagements over time (and also for other reasons such as ad hoc manipulation of the work product model in an individual engagement for some reason), there is a chance that the model of an asset found in the asset repository may not match with that of work products used in the current work product composer. The model of work product(s) is usually externalized from the software stored in a document (e.g., spreadsheet file) and translated into an XML format for automatic software generation. The initial model in a document may come from subject matter experts (SMEs) who understand the work products well—their content and links to other work products.

To match the models of assets with a current work product model, the model of an asset found in the asset repository may be compared with that of the current work product(s) used in the present work product composer. At this point, both the models may be in the same format, for example, an XML format. The comparison can be done automatically by using software such as XML parser that scans through the models and discovers any differences (e.g., in terms of tags and structure of the XML files) between them.

At 216, an evaluation is made as to whether to proceed with matching quality. Matching quality refers to quantitative measurement of degree of match between the models. The match may result in the following outcomes: (1) complete match, (2) incomplete but acceptable match, or (3) no match.

At 218, if the models match completely, the processing proceeds to step 228 in which the assets are converted to model representation that is understood by the work product composer tool. The models match, and therefore, the current work product composer is deemed to be compatible to work with the models of the assets. The model of the assets can be imported and reused by the work product composer tool, for example, work product composer software without further conversion to make the models compatible.

At 216, if no matching quality takes place, the process stops at 220. That is, if the models of the assets do not match the model of the current work product being used in the current work product composer software, the models of the assets are not compatible, and the software may not be able to reuse the assets

At 222, if the matching quality is acceptable, models are mapped at 222. For instance, even if the models do not completely match (e.g., there may be slight difference in the structure of the model or for example, some difference in tag names), the differences are reconcilable. The reconcilable differences may be reconciled or “mapped” by performing a conversion (e.g., converting a tag name from <PMO>to <Project Management Office>) to make a match. The reconciliation may include manual intervention 226, e.g., manual restructuring of the XML file. The outcome will be the asset in the model that completely matches with the model used in the software.

At 224, if acceptable, assets are converted to the model understood by the work product composer tool at 228.

At 224, if not acceptable, the user may review and manually import the asset into the tool at 226.

In one embodiment of the present disclosure, the model representation of assets may include semantic meta-models in which the content represented as objects may be tagged with information, for example, as meta-data. The meta-data associated with the objects may be used to automatically create, store and retrieve documents, for instance, of the same category. The mea-data may be also used for making granular document comparison, and for merge and conflict detection and resolution techniques. Multiple users may collaborate on the same document within the constraints of the popular contemporary document editors based on the merge and conflict resolution techniques.

One or more work products composed at 212, in one embodiment may be traceable depending on whether they have been (a) created new in this project, (b) imported and used as-is from asset repository or (c) imported from asset repository and then modified. Furthermore, a history of the assets may be maintained over a period of time, for example, that tell how different assets have been used in projects, e.g., used as is (hence completely reusable), imported and then modified.

In addition, one or more term glossary, taxonomies, text analytics, semantic Web and/or other techniques may be utilized in building work products and automatically cleansing and replacing client specific terms and the like.

FIG. 3 is a block diagram illustrating a system in one embodiment for creating, linking and using work product models for packaged application practices integrated in conjunction with other functional modules that may utilize the system and method of the present disclosure. A model generator 302 defines and generates models for one or more service delivery methods, for instance, by analyzing work product templates and converting the elements of the work product template into objects and links that form a model representing the service delivery methods structurally.

A “project setter” module 304 receives one or more sets of assets potentially reusable in the current project pushed by asset repository 312, “starter set”. Assets are work products and other project materials. The term “objects” is used herein to refer to elements and components of work products, especially in the context of models of work products above. Examples of work products and assets include PDD (Process Definition Document), Requirement, GAP, RICEFW, etc. A starter set is a set of assets (work products and other project materials and documents) from previous projects that can be reused for the present project, searched and selected from the asset repository based on the characteristics of the present project scope. The project setter module 504 helps the user to select a group of assets useful, for example, by displaying the assets and their content by process groups. The assets (or work products) stored in the asset repository include physical renderings of work products.

“Starter set” assets, for example, assets and other materials, documents in various formats (e.g., MS Word, PowerPoint, Excel, PDF, and others) generated throughout the lifecycle of the project set by a service delivery method, are selectively imported to a “work product composer” module 306 in one or more model-based formats. Work products and assets stored in the repository 312 include physical renderings of the work product instances generated and captured in the work product models (logical entity) generated in the model generator module 302 of the present application. Work products in the repository 312 may also include physical renderings of a service delivery method that are manually generated. The “work product composer” module 306 helps the user to search and pull additional assets from the asset repository 312. Candidate assets are assets from previous projects and stored in the repository that are candidates for reuse in the present project. The project refines the imported and applied asset content through the project's lifecycle by using the work product composer. Applied asset content refers to content of the candidate asset reused in creating a work product for the present project. It may be that a candidate asset may not be reused as it is. However, it provides a starting point with format and content that are reusable. The candidate assets may be refined to fit it to the current project.

“Work product generator” module 308 renders the work products in one or more documents and/or computer programs and publishes them. For instance, the work product composer module 306 outputs the content of work products captured in the models and their implementation in the computer program—that is, the logical entity of the work products. The work product generator module 308 takes this logical entity as input and turns it into a physical entity, for example, Microsoft Word format.

The resulting assets, for example, work products as deliverables (i.e., performed via the service delivery method) to the client may be further run through an “asset harvester” module 310 of the present disclosure, which removes client references and converts the assets into structured format, i.e., a model. The harvested assets are stored in one or more asset repositories 312 for reuse in future projects.

In one aspect of the present disclosure, the user does not have to leave “context” to find and apply assets. This means that the user may define the scope and context of the current project in the Project Setter 304 and once the context is set, the user may “find” assets automatically because the Asset Repository 312 pushes the assets relevant to the current “context”. Then the user may move on to the Work Product Composer 306 to “apply’ the assets in creation of new assets.

A user interface or a development environment may be provided in which a user may interact with various components of the system shown in FIG. 3, for example, to create a structured model representing one or more work products, and/or harvest assets from previously used or created work products (in structured model form or manually generated physical rendering of work products). The information from the generated model may be reused across two or more methodologies to promote collaboration for model definition. That is, models of work products of a service delivery method can be shared for another service delivery method. In addition, existing work products may be utilized to compute new desired feature and evolve existing models that contain those features

Furthermore, one or more links across objects may be followed to “trace” among work products such as from business process to use cases to test plans, to track project progress proactively. Linked models may allow for change in one model to be reflected in related models and policy checks.

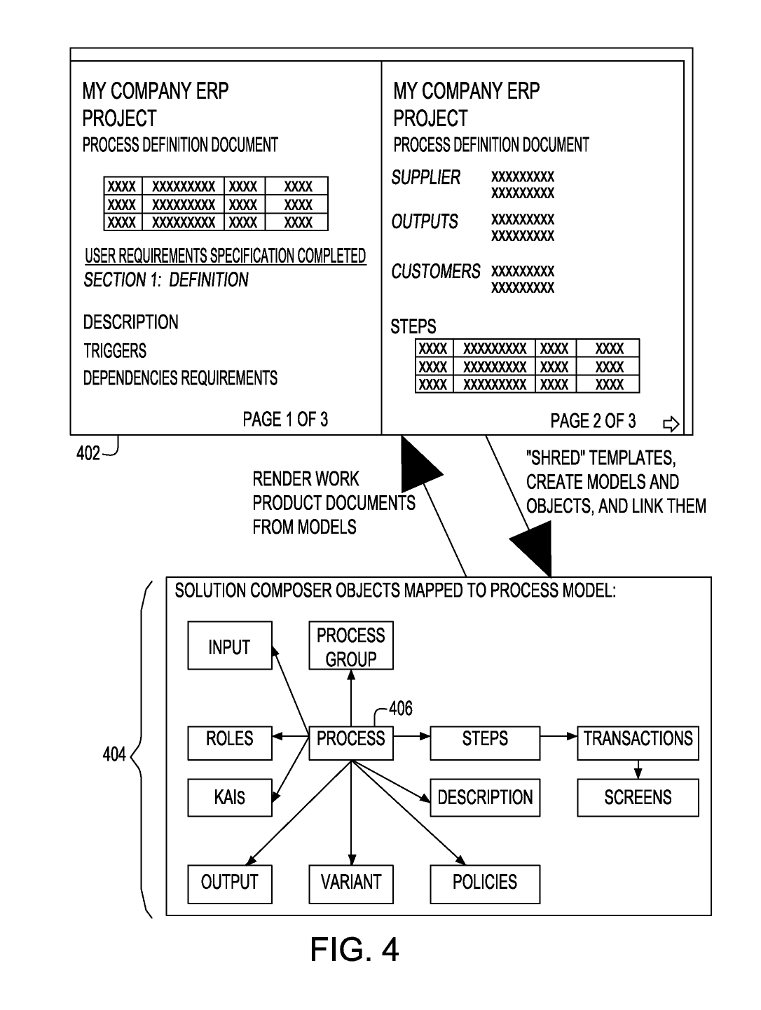

FIG. 4 illustrates an example of a template of a work product and mapping of elements of the template into a model of objects. A sample work product template 402 may be a document that has process description for service delivery methodology such as SAP™ implementation. Elements in the template 402 are mapped or converted into objects and links in a model, i.e., a structured, “object-centric” representation of process information, for example, shown at 404. While the figure does not show every detail of the template to model mappings, it shows example elements of a template and model objects. The work product template 402 is a Process Definition Document (PDD) template. PDD defines processes. In an embodiment, each section of the work product template 402 or document is the definition of a process, for example, “Account Payable.” So, in the model diagram at 404, the process object 406 is at the center. The section (also referred to as an element) of the template 402 may include many subsection or objects, including for example, input, output, trigger, Key Performance Indicators (KPIs), roles, steps, description, and others. Each subsection becomes an object in the work product's model 404 and is linked to the process object.

Once the model is created across multiple work products, a work product is represented as a subset of the model containing the objects, i.e., sections and subsections belonging to the work product.

Some objects in a model may belong to multiple work products. This way, the model is an economic representation of a large set of work products in a service delivery method. The model, when represented in a machine-understandable language like XML, can be processed with computer software or the like.

Appendix I shows an example of a generated model rendered in an XML output format. The model in this example is automatically generated from a set of work product templates defined in one or more packaged application service methods. The model contains a set of objects that are defined and used in the work product templates. In this example, the object names include Document, Scenario, Regulation, Gap, Requirement, Risk, KPI, Project, Process, Step, Customer, Supplier, Input, Output, Role, Business Benefit, Transaction, among others. Each object defined in a model generally matches one or more sections and/or subsection in one or more work products they are extracted from. Often, an object may be defined, described and used in more than one work product instances in a project, and this overlap of objects across two or more work product instances results in one or more links among one or more work products in one or more projects.

The model in this example is represented in a machine understandable markup language referred to as XML. Specifically, the representation of this model example takes a special form of an XML language known as “ecore” as defined in EMF (Eclipse Modeling Framework). EMF provides software tools that can be used to automatically generate computer program code in a high-level language such as Java™ from a model in ecore format. The automatically generated code provides basic user interfaces and services for handling the objects defined in the model. The code can further be customized, refined and augmented for the user interface and services with enhanced operations and features.

For use, the generated model is retrieved, customized and configured. Customizing and configuring may include: (1) making variations to the model such as adding new information entities, removing certain existing ones, (2) adding users and assigning roles, (3) defining what documents are needed. Consultants can search for relevant types of data based on certain pre-defined tags such as industry, process, and others. Once the information authoring is complete, the end deliverable document may be automatically generated. The documents so generated in turn may be used to harvest content from those documents to populate the asset repository.

In one aspect, a server may include the repository of assets and provide services to fetch, save and query for data. A front-end interface, for example, which may be Web 2.0-based, may be used by the consultants or the like to interact to generate documents. Reuse module or the like provides the ability to extract information from documents and store it in the model format. The data-interchange format between the components of the present disclosure may be in XML. The generated model (also referred to as an information model) can be a single model or collection of models, and defines the basic artifact types, their attributes and relationships between them. Rather than keeping the information model static, the on-going customization and configurations allow different models to be dynamically generated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts, or combinations of special purpose hardware and computer instructions.

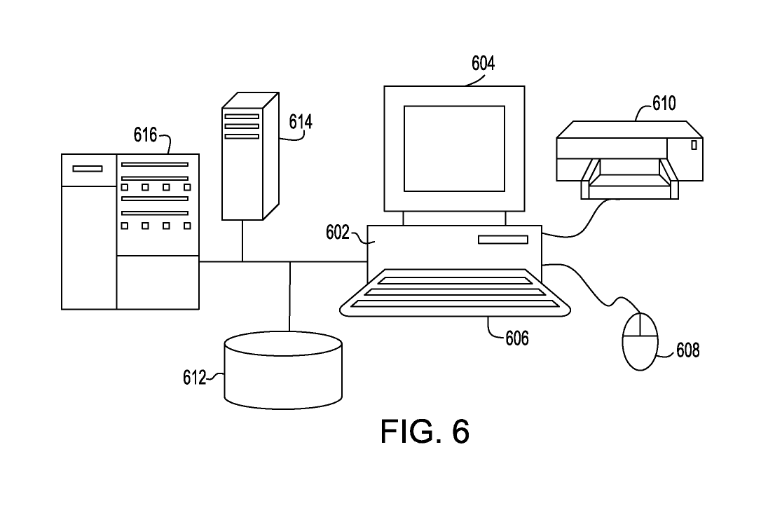

Referring now to FIG. 6, the systems and methodologies of the present disclosure may be carried out or executed in a computer system 602 that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen 604 for presenting output displays and providing a display through which the user may input data and interact with the processing system, for instance, in cooperation with input devices such as the keyboard 606 and mouse device 608 or pointing device. The computer processing system may be also connected or coupled to one or more peripheral devices such as the printer 610, scanner (not shown), speaker, and any other devices, directly or via remote connections. The computer processing system may be connected or coupled to one or more other processing systems such as a server 616, other remote computer processing system 614, network storage devices 612, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems (e.g., 602, 614, 616), or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for reusing assets for packaged software application configurations, comprising:
defining one or more query criteria based on information associated with a project;
querying an asset repository stored in a storage device using the one or more query criteria;
receiving a list of one or more assets from the asset repository in response to the querying; and
using the one or more assets on the list to compose a document defining deployment procedures associated with deploying a packaged software application.

2. The method of claim 1, wherein the step of using includes:
selecting the one or more assets from the list; and
composing the document using the one or more assets.

3. The method of claim 1, further including:
transforming the one or more query criteria into one or more queries to perform on the asset repository.

4. The method of claim 3, further including:
enhancing the one or more queries.

5. The method of claim 3, wherein the steps of transforming and querying are performed automatically after the one or more query criteria are defined and the list of one or more assets are pushed to a user from the asset repository.

6. The method of claim 3, wherein the steps of transforming and querying are performed manually and the list of one or more assets are pulled from the asset repository.

7. The method of claim 1, further including:
annotating the list with information using meta-data associated with the one or more assets.

8. The method of claim 1, further including:
mapping the one or more assets to one or more objects associated with the document.

9. A system for reusing assets for packaged software application configurations, comprising:
a storage device including an asset repository storing a plurality of assets and associated data objects;
a project setter module operable to receive a list of one or more assets from the asset repository in response to querying the asset repository using one or more query criteria based on information associated with a current project;
a work product composer module operable to search and retrieve additional assets from the asset repository; and
a work product generator module operable to generate a document defining deployment procedures associated with deploying a packaged software application for the current project using the one or more assets, the associated data objects, and the additional assets.

10. The system of claim 9, further including:
a user interface module operable to present the one or more assets and enable a user to interact with the project setter module, the work product composer module and the work product generator module, to create the document using the one or more assets in the asset repository.

11. The system of claim 9, wherein the one or more query criteria are used to transform the one or more query criteria into one or more queries for searching the asset repository for one or more assets that are usable for the current project.

12. A computer readable storage medium storing a program of instructions executable by a machine to perform a method for reusing assets for packaged software application configurations, comprising:
defining one or more query criteria based on information associated with a project;
querying an asset repository stored in a storage device using the one or more query criteria;
receiving a list of one or more assets from the asset repository in response to the querying; and
using the one or more assets on the list to compose a document defining deployment procedures associated with deploying a packaged software application.

13. The computer readable storage medium of claim 12, wherein the step of using includes:
selecting the one or more assets from the list; and
composing the document using the one or more assets.

14. The computer readable storage medium of claim 12, further including:
transforming the one or more query criteria into one or more queries to perform on the asset repository.

15. The computer readable storage medium of claim 14, further including:
enhancing the one or more queries.

16. The computer readable storage medium of claim 14, wherein the steps of transforming and querying are performed automatically after the one or more query criteria are defined and the list of one or more assets are pushed to a user from the asset repository.

17. The computer readable storage medium of claim 14, wherein the steps of transforming and querying are performed manually and the list of one or more assets are pulled from the asset repository.

18. The computer readable storage medium of claim 12, further including:
annotating the list with information using meta-data associated with the one or more assets.

19. The computer readable storage medium of claim 12, further including:
mapping the one or more assets to one or more objects associated with the document.
